(19) United States
(12) Patent Application Publication
(10) Pub. No.: US 2022/0093951 A1
(43) Pub. Date: Mar. 24, 2022

(54) UNIT FUEL CELL, FUEL CELL STACK AND BIPOLAR PLATE ASSEMBLY

(71) Applicant: POWERCELL SWEDEN AB, 418 34 Göteborg (SE)

(72) Inventors: Robin VELÉN, Hovas (SE); Stefan Munthe, Vasta Frolunda (SE)

(73) Assignee: POWERCELL SWEDEN AB, 418 34 Göteborg (SE)

(21) Appl. No.: 17/423,931

(22) PCT Filed: Nov. 18, 2019
(86) PCT No.: PCT/EP2019/081603

§ 371 Date: Jul. 19, 2021

(30) Foreign Application Priority Data
Jan. 23, 2019 (SE) 1930019-3

(51) Int. Cl. H01M 8/1004; H01M 8/0247; H01M 8/0271

(52) U.S. Cl. CPC H01M 8/1004; H01M 8/0271; H01M 8/0247

(57) ABSTRACT

A fuel cell stack includes a plurality of bipolar plates wherein each bipolar plate has at least an anode plate and a cathode plate, and a plurality of membrane electrode assemblies being sandwiched by the bipolar plates, wherein each membrane electrode assembly has at least an anode and a cathode which are separated by a membrane, wherein the bipolar plates sandwich the membrane electrode assembly in such a way that the anode of the membrane electrode assembly faces the anode plate of a first bipolar plate and the cathode of the same membrane electrode assembly faces the cathode plate of a second bipolar plate; and wherein a cell pitch of the fuel cell stack is defined by a distance of two adjacent membrane electrode assemblies, wherein at borders of the bipolar plates of the fuel cell stack, an overall distance between the anode plate of the first bipolar plate and the cathode plate of the second bipolar plate, which is measured over the sandwiched membrane electrode assembly, is equal to the cell pitch of the fuel cell stack.

### BACKGROUND AND SUMMARY

The present invention relates to a unit fuel cell, a fuel cell stack and a bipolar plate assembly.

Usually, a fuel cell stack comprises a plurality of unit fuel cell, or more generally, a plurality of membrane electrode assemblies (MEAs), which are separated by so called bipolar plate assemblies. The bipolar plate assemblies themselves usually comprise at least two metal plates, so called flow field plates, which are placed on top of each other and have a flow field for the reactants at one side and a flow field for a cooling fluid on the other side. In the bipolar plate assembly, the cooling fluid flow fields are facing each other, wherein the reactant fluid flow fields are arranged at the outside surfaces of the bipolar plate assembly, which face the MEAs. The electric current produced by the MEAs during operation of the fuel cell stack results in a voltage potential difference between the bipolar plate assemblies. Consequently, the individual bipolar plate assemblies or unit fuel cells must be kept electrically separated from each other under all circumstances in order to avoid a short circuit.

For the electrical separation an insulating layer is provided, the so called sub-gasket, which is arranged at or surrounds the periphery of the membrane electrode assembly, whereby a membrane-electrode-subgasket assembly is formed. The subgasket normally extends beyond the borders of the bipolar plate assembly in order to achieve a sufficient short circuit protection. Disadvantageously, this results in a design of a fuel cell stack with uneven sidewalls, which interfere with a prober arrangement of the fuel cell stack in e.g. a housing.

However, when assembling a fuel cell stack, the bipolar plate assemblies and the MEAs have to be precisely aligned to each other in order to ensure working of the fuel cell stack. For facilitating the alignment, it is known to have, at each bipolar plate assembly and also at the membrane-electrode-subgasket assembly, at least one, preferably two specific areas, where the geometry of the bipolar plate/membrane-electrode-subgasket assembly allows for the arrangement of an aligning tool. Such an aligning tool may be a so called guiding rod or a guiding wall, which define the outer dimensions of the final fuel cell stack.

For a precise alignment of the elements of the fuel cell stack, it is necessary that at least in these areas, preferably everywhere, the subgaskets do not extend over the borders of the bipolar plate assemblies. Unfortunately, this also means that in these areas an insufficient electrical separation occurs, so that these areas run a risk of a short circuit, mainly due to bent bipolar plates and/or inadequate assembly.

Consequently, it is desirable to provide fuel cell stack having an adjusted geometry so that the electrical hazards are eliminated.

In the following a fuel cell stack is provided which comprises a plurality of bipolar plates wherein each bipolar plate has at least an anode plate and a cathode plate, and a plurality of membrane electrode assemblies being sandwiched by the bipolar plates, wherein each membrane electrode assembly has at least an anode and a cathode which are separated by a membrane, wherein the bipolar plates sandwich the membrane electrode assembly in such a way that the anode of the membrane electrode assembly faces the anode plate of a first bipolar plate and the cathode of the same membrane electrode assembly faces the cathode plate of a second bipolar plate. Further a cell pitch of the fuel cell stack is defined by a distance of two adjacent membrane electrode assemblies.

In order to provide a fuel cell stack with reduced risk for electrical short circuit it is proposed that at borders of the bipolar plates of the fuel cell stack, an overall distance between the anode plate of the first bipolar plate and the cathode plate of the second bipolar plate, which is measured over the sandwiched membrane electrode assembly, is equal to the cell pitch of the fuel cell stack.

According to a preferred embodiment, at the borders of the bipolar plates of the fuel cell stack, the anode plate of the first bipolar plate has a first distance to the membrane electrode assembly and the cathode plate of the second bipolar plate has a second distance to the membrane electrode assembly, wherein the first distance is different from the second distance. Thereby the risk for any short circuit may be further prevented.

According to a further aspect of the invention, this feature may be implemented also in a unit fuel cell. A unit fuel cell usually comprises an anode and a cathode plate sandwiching a membrane electrode assembly. Even if such a unit fuel cell could also be used a stand-alone fuel cell, the voltage provide by such a unit fuel cell is quite small. Consequently, these unit fuel cells are stacked for forming a fuel cell stack, in which the voltages produced by each single unit fuel cell sum up to a sufficiently large voltage for most applications. Thereby, the backsides of the anode and cathode plate of two unit fuel cells are placed in contact with each other and thus form a bipolar plate assembly.

The unit fuel cell or at least one of the unit fuel cells of the fuel cell stack has at least an anode plate and a cathode plate sandwiching a membrane-electrode-assembly (MEA), wherein the MEA has at least an anode and a cathode, which are separated by a membrane. Thereby, the anode is facing the anode plate and the cathode is facing the cathode plate. As mentioned above for avoiding any short circuit, it is proposed that the anode plate has a first distance to the MEA and the cathode plate has a second distance to the MEA, wherein the first and second distance differ. Thereby it should be noted, that the first and second distances are determined or measured at the same location.

Usually both cathode and anode plates have an identical design, where from a stability reason the borders are separated from each other so that the distances between the plates and the MEA are quite small. This also results in a symmetric arrangement at the MEA and therefore in identical distances to the MEA. As mentioned above the risk for short circuits may be avoided by increasing this distance to the cell pitch. However, this might result in a loss of stability. Due to the proposed different distances, the risk for a short circuit can be avoided, even if one of the plates is bended or the accuracy of the assembly is inadequate.

The different distances have the further advantage that at the location of the larger distance sufficient space for a welding seam may be provided. This allows for a facilitated bonding of anode and cathode plates of two different unit fuel cells for forming the bipolar plate assembly, as will be explained in detail further below.

According to a preferred embodiment the membrane electrode assembly of the unit fuel cell further has a subgasket which is at least partly arranged in an encompassing way around the anode and the cathode and the first and second distance are determined between the anode plate and the subgasket and the cathode and the subgasket, respectively. Thereby, it is particularly preferred, if the subgasket encompasses the anode and cathode in a frame-like manner. This design allows for a good electric isolation of the anode and cathode of the membrane electrode assembly.

According to a further preferred embodiment the location at which the first and second distance are determined and/or measures is arranged at the border of the unit fuel cell. The borders of the plates are very sensitive to bending as the plates themselves are usually quite thin, roughly in the range of 0.05 to 0.1 mm, and the borders are used for aligning the unit fuel cells, which in turn increases the risk for damaging the plates in the border region. Due to the distance of one cell pitch the plates are more or less in contact with each other, which increases the stability. In the preferred case of the different distances, the stability is further increased and the risk for short circuits is nevertheless avoided.

It is further preferred that the anode plate and/or the cathode plate has a first area with a first structure and a second area with a second structure, wherein in the first area, the first structures of the anode and the cathode plate are identical channel-like structures comprising recesses and elevations, and in the second area, the second structure of the anode plate differs from the second structure of the cathode plate, even if the second structures may also provide a channel-like structure. The channel-like structures of at least the first area form a fluid flow field for the reactants which are to be distributed at the anode and/or cathode of the membrane electrode assembly. The different design of the first and second structures allows for an optimized fluid distribution in the first area by means of the first structures, and on the other hand for an optimized stability in the second area by means of the second structures.

Consequently, it is particularly preferred if the first area is formed in an active region of the unit fuel cell and the second area is formed in an border region of the unit fuel cell, wherein, on the anode side, the active region is defined by the extension of the anode, and, on the cathode side, the active region is defined by the extension of the cathode, and the border area is defined by the extension of the subgasket which encompasses the anode and/or cathode. This allows for a maximization of the active area and simultaneously for an increased stability of the unit fuel cells.

A further aspect of the present invention relates to a fuel cell stack comprising at least a first and a second unit fuel cell as mentioned above, wherein the first unit fuel cell and the second unit fuel cell are arranged on top of each other so that the cathode plate of the first unit fuel cell is facing to and/or contacting the anode plate of the second unit fuel cell, whereby the cathode plate and anode plate form the bipolar plate assembly.

The above discussed new design of the anode and cathode plate provide for a bipolar plate assembly in the fuel cell stack, which is more stable and which may be electrically isolated from any other adjacent bipolar plate assembly in the fuel cell stack, even if the subgasket does not provide a sufficient isolation, e.g. due to manufacturing inaccuracies or tolerances. The new design of the bipolar plate assembly also allows for a better short-circuit protection between adjacent bipolar plate assemblies in the fuel cell stack, since in the second area the distances between adjacent bipolar plates assemblies is increased.

Consequently and according to a further aspect of the present invention, a bipolar plates assembly is preferred, which has, in general, a first and second flow field plate, namely the anode plate and the cathode plate, each of which have a front side and a backside, wherein the backsides are facing each other. Further, both plates have a first area with a first structure, e.g. on the backside, and a second area with a second structure, e.g. on the backside. Thereby in the first area, the first structure is a channel like structure comprising recesses and elevations, wherein the elevations of the anode and cathode plate are arranged to face and contact each other, and the recesses of the anode and cathode plate are arranged opposite of each other thereby forming cooling fluid flow field channels of the bipolar plate. In contrast to that, in the second area, the second structure of one of the plates, either the anode or the cathode plate, is provided with a first set of elevations and a second set of elevations, whereas the second structure of the respective other plate is provided with recesses and elevations, wherein the elevations of the first set of elevations are arranged to face and contact the elevations of the respective other plate, and the elevations of the second set of elevations are arranged to face the recesses of the other plate. Hence, in the second area either the second set of elevations of the anode plate is accommodated in the recesses of the cathode plate, or, vice versa, the second set of elevations of the cathode plate is accommodated in the recesses of the anode plate.

Thereby, in the second area, the bipolar plate assembly is more stable as the two plates support each other and are thus stronger than just a single plate. Consequently, they can better withstand any bending forces. On the other hand, due to this arrangement, the overall distance of two adjacent bipolar plate assemblies is increased so that the risk for short circuits due to contacting bipolar plates is decreased or avoided. Additionally, the design allows for a plurality of possibilities to connect the anode and the cathode plate in the second are. Particularly, it is possible to weld the plates together, e.g. by ultra-sonic welding. In the enlarged distance to the MEA provided by the new design it is possible to accommodate a welding seam, so that when combining the bipolar plate assembly with the membrane electrode assembly the membrane electrode assembly will remain flat and will not bend or bulge over the welding seam.

According to a further preferred embodiment of the fuel cell stack or the bipolar plate assembly and as mentioned above, the second area is arranged at an outer region or border region of the anode and cathode plate. As explained above, in a fuel cell or a fuel cell stack, the outer region of adjacent bipolar plate assemblies are usually separated form each other by the subgasket which encompasses the membrane electrode assembly. Preferably, this subgasket should have the same extension as the bipolar plate assemblies, but due to manufacturing inaccuracies or tolerances, the subgasket does not always have the same extension as the bipolar plate. Consequently, there might be regions in which the bipolar plates assemblies are not sufficiently electrically isolated from each other, so that the risk for a short circuit is increased. Since this is usually in the outer or border region of the bipolar plate assembly, the arrangement of the second area in this border region is preferred.

As also already mentioned above, it is it further preferred, if the second area surrounds the first area frame likely, so that the increased distance between two adjacent bipolar plate assemblies is provided in the complete outer region of the bipolar plate assembly.

In a further preferred embodiment, the anode plate and the cathode plate have a reactant flow field on the front side, wherein also each reactant flow field has recesses and elevations. Thereby, the recesses of the reactant flow field are formed by the elevations of cooling fluid flow field, and the elevations of the reactant flow field are formed by the recesses of the cooling fluid flow field.

Due to this, the anode/cathode plate may be manufactured by a single coining or stamping process and the overall thickness of the anode/cathode plate may be further reduced and a single plate may be provided for both the reactant flow field and the cooling fluid flow field. This allows for a reduced overall thickness of the bipolar plate assembly and for facilitating the stacking process.

According to another preferred embodiment, in the first area, an active region of the reactant flow field is formed on each front side of the first and second flow field plate, and an border region of the reactant flow field is formed in the second area. With this design it is possible to adapt the active region of the flow field plate to the electrodes of the membrane electrode assembly and the border region to the subgasket which encompasses the membrane electrode assembly. This design allows for both an enlarged active region and an improved short-circuit protection.

According to a further preferred embodiment of the fuel cell stack, in the second area, the anode plate of a first the bipolar plate assembly has a first distance to its respective adjoining subgasket, and the cathode plate of a second bipolar plate assembly has a second distance to the respective adjoining subgasket, wherein the first distance and the second distance differ from each other. Thereby, the sum of the first distance and the second distance corresponds to the overall distance between two adjacent bipolar plate assemblies or two anode plates and two cathode plates in the fuel cell stack. This allows for a maximized distance between the bipolar plate assemblies in the border region, which in turn decreases the risk for short circuits, even if the bipolar plates are bended or the subgasket is insufficiently formed or damaged.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

The figures show:

FIG. 1: A schematic cross-sectional view of a fuel cell stack according to the state-of-the-art:

FIG. 2: a schematic cross-sectional view of a fuel cell stack according to a preferred embodiment of the present invention; and

FIG. 3: a schematic cross-section of a fuel cell stack according to a further preferred embodiment of the present invention.

### DETAILED DESCRIPTION

In the following same or similar functioning elements are indicated with the same reference numerals.

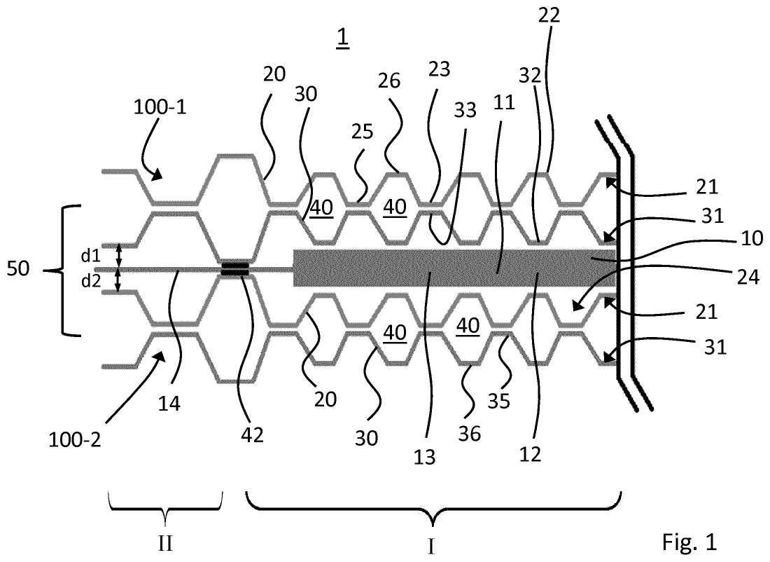

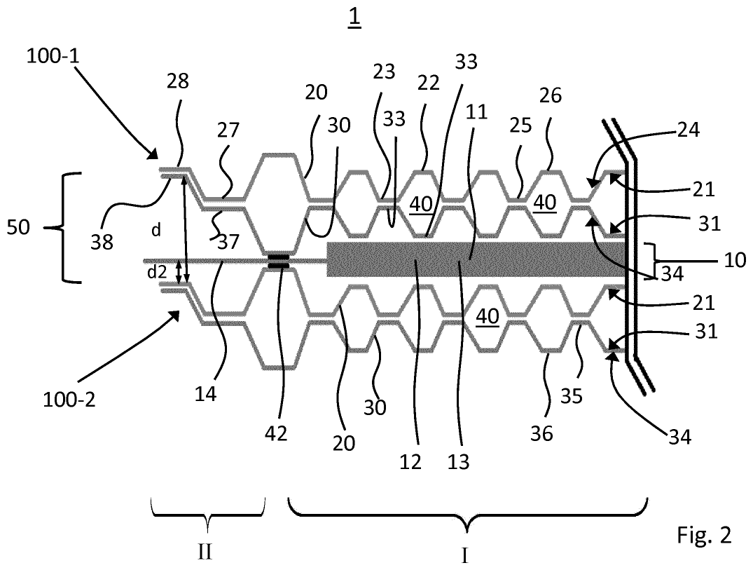

FIGS. 1 and 2 show each a schematic cross-section of a part of a fuel cell stack 1. The fuel cell stack 1 has a membrane electrode assembly 10 which is sandwiched between two bipolar plate assemblies 100-1 and 100-2. The membrane electrode assembly 10 usually comprises a cathode 11 and an anode 12 which are separated by a membrane 13, and form the active region of the membrane electrode assembly 10. The active region is encompassed a subgasket 14.

As can be further seen in FIG. 1 and FIG. 2, the membrane electrode assembly 10 is sandwiched between two adjacent bipolar plate assemblies 100-1 and 100-2. Each bipolar plate assembly has a first flow field plate 20 (e.g. an anode plate), and a second flow field plate 30 (e.g. a cathode plate), which are in contact with the respective electrode of the membrane electrode assembly 10. Hence, the first flow field plate 20 of the first bipolar plate assembly 100-1, the MEA 10 and the second flow field plate 30 of the second bipolar plate assembly 30 form a unit fuel cell 50. In the following the first flow field plate 20 is regarded as the anode plate 20 and the second flow field plate 30 is regarded as the cathode plate. However, it should be noted that this may be the other way round without departing from the scope of the invention.

Each bipolar plate assembly 100-1, 100-2 or better each flow field plate 20, 30 has on its back side 21, 31 a cooling fluid flow field structure with cooling fluid flow field structures in the form of recesses 22, 32, and elevations 23, 33. Since both backsides 21, 31 are arranged to face each other the cooling fluid flow field structures form cooling fluid flow field channels 40 through which a cooling fluid may be guided for cooling the bipolar plate assembly 100-1, 100-2 and thereby the fuel cell stack 1.

On the front side 24, 34, namely at the side facing the electrodes, a reactant flow field is provided which also has also recesses 25, 35 and elevations 26, 36. In the depicted embodiments, the recesses 22, 32 and elevations 23, 33 of the cooling fluid flow field form the elevations 26, 36 and the recesses 25, 35 of the reactant flow field, respectively. This allows for a simplified manufacturing of the flow field plates 20, 30, as the flow field plate 20, 30 may be manufactured by a single coining or stamping process.

As can be further seen in FIGS. 1 and 2, the respective reactant flow fields are separated by the membrane electrode assembly 10 and by the subgasket region 14. Additionally, they are sealed from the outside by sealing elements 42 which are arranged between the flow field plates 20, 30, and the subgasket 14.

In the fuel cell stack according to the state-of-the-art as depicted in FIG. 1, the anode plate 20 and the cathode plate 30 are formed identical. Hence, when arranging the flow field plates 20, 30 with their backsides 21, 31 facing each other, all recesses 22, 32 of the cooling fluid flow field of anode plate 20 and cathode plate 30 are facing each other. This design has the disadvantage that a first distance d1 between the cathode plate 30 of the bipolar plate assembly 100-1 and the respective adjoining subgasket 14, and a second distance d2 between the anode plate 20 of the bipolar plate assembly 100-2 and the respective adjoining subgasket 14, are are quite small. Consequently, there is a high risk for a short circuit, in case one of the bipolar plates is bended or the subgasket 14 is damaged or missing in this area, as the bipolar plate assemblies 100-1, 100-2 may come into contact with each other.

Referring now to FIG. 2, in contrast to that, the first and second flow field plates 20, 30 of the depicted embodiment of the present invention, are only identical in a first area I. In a second area II, the anode plate 20 has a first set of elevations 27 and a second set of elevations 28, whereas the cathode plate 30 still has elevations 37 and recesses 38. Thereby, the second set of elevations 28 is accommodated in the recesses 38. This in turn, allows for an enlarged distance d1 between the anode plate 20 of the first bipolar plate assembly 100-1 and the neighboring subgasket 14, wherein the distance d2 between the cathode plate 30 of the second bipolar plate assembly 100-2 and the same subgasket 14 is quite small, e.g. in the same range as known from the state of the art. Additionally, the overall distance is one cell pitch, which ensures an improved short circuit avoidance.

This newly developed design has the advantage that the border region (second area) of the bipolar plate assembly is more stable since two plates provide a higher stiffness than a single plate. Usually, an anode/cathode plate has a width of roughly 0.075 mm and is therefore very sensitive to bending or other damages.

This increased strength has the further advantage that the bipolar plate assembly may be welded in the very outer/border region. Due to the increased strength a counter-force may be applied by the opposite side of the bipolar plate assembly without damaging the assembly (e.g. bending the plates).

Preferably, the distance d1 is about the same as for the bead seal, so that when combining (stacking) the bipolar plate assemblies and the MEA, the MEA remains flat. In case the distance d1 is not large enough it is necessary to weld at the bottom of the flow field —namely in the recesses—which creates a bending in the membrane electrode assembly.

The overall distance of two adjacent plates is one cell pitch which is the maximal possible distance between two plates and therefore ensures that a short circuit may be avoided.

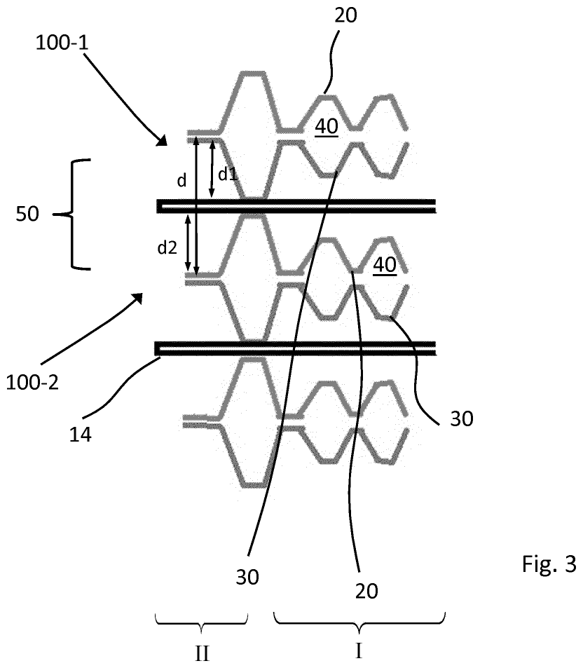

FIG. 3 shows a further preferred embodiment of the fuel cell stack, where the distance of the adjacent bipolar plate assemblies 100-1, and 100-2 is also one cell pitch. In contrast to the embodiment depicted in FIG. 2, there is no different distance between the plates to the gasket, but both are equally spaced by one cell pitch so that also in this embodiment a short circuit may be avoided.

In summary, due to the new design, the electrical insulation between adjacent bipolar plate assemblies 100-1, 100-2 is ensured even in regions where the subgasket part 14 is not sufficiently large compared to the extension of the bipolar plate assemblies 100-1, 100-2, or otherwise damaged, or insufficiently aligned. Additionally, the overall strength of the bipolar plate assembly and the fuel cells is improved.

### REFERENCE SIGNS

1 Fuel cell stack
10 membrane electrode assembly
100 Bipolar plate assembly
I first area
II second area
11 anode
12 cathode
13 membrane
14 subgasket
20 first (anode) flow field plate
30 second (cathode) flow field plate
21, 31 backside of the flow field plate
22, 32 elevations on the backside (first area)
23, 33 recesses on the backside (first area)
24, 34 frontside
25, 35 elevation on the frontside (first area)
26, 36 recess on the frontside (first area)
27 first set of elevations on the front side (second area)
28 second set of elevations on the front side (second side)
37 elevations (second area)
38 recess (second area)
40 Cooling fluid flow channels
50 unit fuel cell

1. Fuel cell stack comprising
a plurality of bipolar plates wherein each bipolar plate has at least an anode plate and a cathode plate, and
a plurality of membrane electrode assemblies being sandwiched by the bipolar plates, wherein each membrane electrode assembly has at least an anode and a cathode which are separated by a membrane,
wherein the bipolar plates sandwich the membrane electrode assembly in such a way that the anode of the membrane electrode assembly faces the anode plate of a first bipolar plate and the cathode of the same membrane electrode assembly faces the cathode plate of a second bipolar plate; and
wherein a cell pitch of the fuel cell stack is defined by a distance of two adjacent membrane electrode assemblies
wherein at borders of the bipolar plates of the fuel cell stack, an overall distance (d) between the anode plate of the first bipolar plate and the cathode plate of the second bipolar plate, which is measured over the sandwiched membrane electrode assembly, is equal to the cell pitch of the fuel cell stack.

2. Fuel cell stack according to claim 1, wherein at the borders of the bipolar plates of the fuel cell stack, the anode plate of the first bipolar plate has a first distance to the membrane electrode assembly and the cathode plate of the second bipolar plate has a second distance to the membrane electrode assembly, wherein the first distance is different from the second distance.

3. Fuel cell stack according to claim 1, wherein the membrane electrode assembly further has a subgasket, which is at least partly arranged in an encompassing way around the anode and the cathode and the first and second distance are determined between the anode plate and the subgasket and the cathode and the subgasket, wherein preferably the subgasket encompasses the anode and cathode in a frame-like manner.

4. Fuel cell stack according to claim 1, wherein the anode plate and/or the cathode plate of at least one bipolar plate has a first area with a first structure and a second area with a second structure, wherein in the first area, the first structures of the anode and the cathode plate are identical channel-like structures comprising recesses and elevations, and in the second area, the second structures of the anode and cathode plate are also channel-like structures, wherein the second structure of the anode plate differs from the second structure of the cathode plate.

5. Fuel cell stack according to claim 4, wherein the first area is formed in an active region and the second area is formed in a border region, wherein, on the anode side, the active region is defined by the extent of the anode, and, on the cathode side, the active region is defined by the extent of the cathode, and the border region is defined by the extent of the subgasket which extends over the anode and/or cathode.

6. Fuel cell stack according to claim 4, wherein in at least one bipolar plate the second structure of either anode plate or cathode plate is provided with a first set of elevations and a second set of elevations, and the second structure of the respective other plate, namely cathode plate or anode plate, is provided with recesses and elevations, wherein the elevations of the first set of elevations of anode/cathode plate are arranged to face and/or contact the elevations of cathode/anode plate and the elevations of the second set of elevations of the anode/cathode plate are arranged to face the recesses of the cathode/anode plate, so that the elevations of the second set of elevations of anode/cathode plate are accommodated in the recesses of the cathode/anode plate.

7. Fuel cell stack according to claim 4, wherein the anode and cathode plate of the bipolar plate have a front side and a backside, wherein the first and second structures are arranged at the backside, and wherein, in the first area, the recesses of the backsides of the anode and cathode plate are arranged opposite of each other, thereby forming cooling fluid flow field channels of the bipolar plate.

8. Fuel cell stack according to claim 7, wherein at least in the first area the anode plate and/or the cathode plate has a reactant flow field on the frontside, wherein each reactant flow field has recesses and elevations, which are formed by the respective elevations and recesses of the backsides.

9. Unit fuel cell for a fuel cell stack according to claim 1.

10. Bipolar plate for a fuel cell stack according to claim 1 comprising at least an anode plate with a front side and a backside and a cathode plate with a frontside and a backside, wherein the backsides of anode plate and cathode plate are facing each other, and wherein both the anode and cathode plate have a first area with a first structure on the backside and a second area with a second structure on the backside, wherein in the first area, the first structure is a channel like structures comprising recesses and elevations, wherein the elevations of the anode and cathode plate are arranged to face and contact each other, and the recesses of the anode and cathode plate are arranged opposite of each other thereby forming cooling fluid flow field channels of the bipolar plate, and wherein in the second area, the second structure of either the anode plate or the cathode plate is provided with a first set of elevations and a second set of elevations, and the second structure of the respective other plate is provided with recesses and elevations, wherein the first set of elevations is arranged to face and contact the elevations of the respective other plate and the second set of elevations is arranged to face the recesses of the respective other plate, so that the second set of elevations is accommodated in the recesses of the respective other plate.
